(19) United States
(12) Patent Application Publication
(10) Pub. No.: US 2024/0322467 A1
(43) Pub. Date: Sep. 26, 2024

(54) BOARD CONNECTOR AND DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Toshikazu SUZUKI, Osaka (JP); Toshifumi ICHIO, Osaka (JP); Daisuke ITO, Osaka (JP); Kazuki HIRAMATSU, Mie (JP); Taiga KADOYAMA, Mie (JP)

(21) Appl. No.: 18/291,741

(22) PCT Filed: Jun. 27, 2022
(86) PCT No.: PCT/JP2022/025498

§ 371 Date: Jan. 24, 2024

(30) Foreign Application Priority Data
Jul. 26, 2021 (JP) 2021-121687

(51) Int. Cl. H01R 12/72; H01R 13/6596

(52) U.S. Cl. CPC H01R 12/722; H01R 13/6596

(57) ABSTRACT

A board connector 10 of the present disclosure is to be mounted on a circuit board 50 accommodated inside an enclosure 64 made of metal, and provided with a housing 11 including a receptacle 15 open forward and a rear wall 30 provided on a side opposite to a front end part 16 where the receptacle 15 is open, an outer conductor 20 fixed to the housing 11 through the rear wall 30, an insulating dielectric 19 disposed inside the outer conductor 20, an inner conductor 18 disposed inside the dielectric 19, and a ground spring 40 to be connected to the outer conductor 20. The ground spring 40 includes a contact point portion 48 having a curved surface shape projecting toward the enclosure 64, and the contact point portion 48 resiliently contacts the enclosure 64.

### TECHNICAL FIELD

The present disclosure relates to a board connector and a device.

### BACKGROUND

Conventionally, a connector described in Japanese Patent Laid-Open Publication No. 2016-207411 (Patent Document 1 below) is known as a connector to be mounted on a circuit board. This connector includes electrically conductive signal terminals, an insulating housing for holding the signal terminals, an electrically conductive shell for covering the housing, an electrically conductive upper-stage ground terminal disposed above the signal terminals and held in the housing, and an electrically conductive lower-stage ground terminal disposed below the signal terminal and held in the housing. The upper-stage ground terminal includes a contact portion to be brought into contact with a back surface side of the shell.

The shell is a member for shielding the signal terminals of the connector from external electrical noise and establishing ground connection of the upper-stage ground terminal. The shell has a box shape with open front and lower surfaces. A part of the upper surface of the shell is cut and bent outward and serves as a shell-side ground connecting portion to be connected to a ground terminal of a unit enclosure for accommodating the connector. The back surface of the shell has a contact surface to be brought into contact with the contact portion of the upper-stage ground terminal.

The upper-stage ground terminal has a function as a ground terminal to be ground-connected by being connected to female ground of a mating connector. The contact portion of the upper-stage ground terminal is in contact with the contact surface of the shell, and the shell-side ground connecting portion is in contact with the ground terminal of the unit enclosure. In this way, a ground line to the ground terminal of the unit enclosure is configured via the female ground, the upper-stage ground terminal, the shell and the shell-side ground connecting portion of the shell.

### PRIOR ART DOCUMENT

### Patent Document

Patent Document 1: JP 2016-207411 A

### SUMMARY OF THE INVENTION

### Problems to be Solved

In the above connector, the shell-side ground connecting portion is formed to project rearward from a front end part of the upper surface of the shell. Thus, to prevent the shell-side ground connecting portion from being turned up and broken, the unit enclosure needs to be assembled with the connector from front. However, an assembly direction of the enclosure may be restricted by an assembly environment at a deliver destination and is desirably freely selectable.

A technique disclosed in this specification was completed on the basis of the above situation and aims to provide a board connector and a device enabling an assembly direction of an enclosure to be freely selected.

### Means to Solve the Problem

The present disclosure is directed to a board connector to be mounted on a circuit board accommodated inside an enclosure made of metal, the board connector being provided with a housing including a receptacle open forward and a rear wall provided on a side opposite to a front end part where the receptacle is open, an outer conductor fixed to the housing through the rear wall, an insulating dielectric disposed inside the outer conductor, an inner conductor disposed inside the dielectric, and a ground spring to be connected to the outer conductor, the ground spring including a contact point portion having a curved surface shape projecting toward the enclosure, the contact point portion resiliently contacting the enclosure.

### Effect of the Invention

According to the present disclosure, it is possible to provide a board connector enabling an assembly direction of an enclosure to be freely selected.

### BRIEF DESCRIPTION OF THE DRAWINGS

FIG. 1 is a perspective view showing a board connector of a first embodiment.

FIG. 2 is an exploded perspective view of a device.

FIG. 3 is a front view of the board connector.

FIG. 4 is a side view of the board connector.

FIG. 5 is a perspective view showing the board connector before an outer conductor is fixed to a housing.

FIG. 6 is a section along A-A of FIG. 3.

FIG. 7 is a section along B-B of FIG. 3.

FIG. 8 is a section along C-C of FIG. 4.

FIG. 9 is a section along D-D of FIG. 4.

FIG. 10 is a side view in section of the device showing a state where an enclosure is assembled with the board connector.

FIG. 11 is a top view in section of the device showing a state before the enclosure is assembled from behind the board connector.

FIG. 12 is a top view in section of the device showing the state where the enclosure is assembled with the board connector.

FIG. 13 is a front view in section of the device showing a state before the enclosure is assembled from above the board connector.

FIG. 14 is a front view in section of the device showing the state where the enclosure is assembled with the board connector.

FIG. 15 is a side view in section of a device showing a state where an enclosure is assembled with a board connector of a second embodiment.

FIG. 16 is a top view in section of the device showing the state where the enclosure is assembled with the board connector of the second embodiment.

### DETAILED DESCRIPTION TO EXECUTE THE INVENTION

### Description of Embodiments of Present Disclosure

First, embodiments of the present disclosure are listed and described.
(1) The board connector of the present disclosure is to be mounted on a circuit board accommodated inside an enclosure made of metal, and provided with a housing including a receptacle open forward and a rear wall provided on a side opposite to a front end part where the receptacle is open, an outer conductor fixed to the housing through the rear wall, an insulating dielectric disposed inside the outer conductor, an inner conductor disposed inside the dielectric, and a ground spring to be connected to the outer conductor, the ground spring including a contact point portion having a curved surface shape projecting toward the enclosure, the contact point portion resiliently contacting the enclosure.

A device of the present disclosure is provided with the board connector, a circuit board having the board connector mounted thereon, and an enclosure made of metal, the circuit board being accommodated inside the enclosure, the enclosure being electrically connected to the outer conductor via the ground spring, the enclosure including a shield connection wall configured to slide on the contact point portion during assembly of the enclosure and resiliently contact the contact point portion after the assembly of the enclosure is completed.

Since the ground spring includes the contact point portion having a curved surface shape projecting toward the enclosure, the shield connection wall slides on the contact point portion during the assembly of the enclosure and resiliently contacts the contact point portion after the assembly of the enclosure is completed. Thus, the ground spring can be prevented from being partially turned up and broken, and an assembly direction of the enclosure can be freely selected. Further, since the outer conductor and the enclosure made of metal can be electrically connected via the ground spring, a connected state is stable and shielding performance can be improved.
(2) Preferably, the ground spring includes a mounting body portion to be disposed along an outer surface of the rear wall and a resilient piece projecting forward from a front edge of the mounting body portion, and the contact point portion is provided on a front end side of the resilient piece.

The contact point portion is displaced while deflecting the resilient piece when the enclosure contacts the contact point portion, and the contact point portion resiliently contacts the enclosure by the resilient return of the resilient piece.
(3) Preferably, the mounting body portion is gate-shaped and includes a pair of arm portions and a coupling portion coupling the pair of arm portions, and at least one resilient piece is provided in each of the pair of arm portions.

Since the ground spring includes at least a pair of the resilient pieces, the ground spring can be shield-connected to the enclosure at least at two positions and noise can be reduced.
(4) Preferably, a pair of the resilient pieces are provided in one arm portion and a pair of the resilient pieces are provided in the other arm portion.

Since the ground spring includes fourth resilient pieces, the ground spring can be shield-connected to the enclosure at least at four positions and noise can be further reduced.
(5) Preferably, the contact point portion is formed by causing an inner part of the resilient piece except an outer peripheral edge part to project in a plate thickness direction.

Since the contact point portion is constituted by the inner part of the resilient piece, the resilient piece can be prevented from being turned up, such as due to the enclosure caught by the outer peripheral edge part of the resilient piece.

### Details of First Embodiment of Present Disclosure

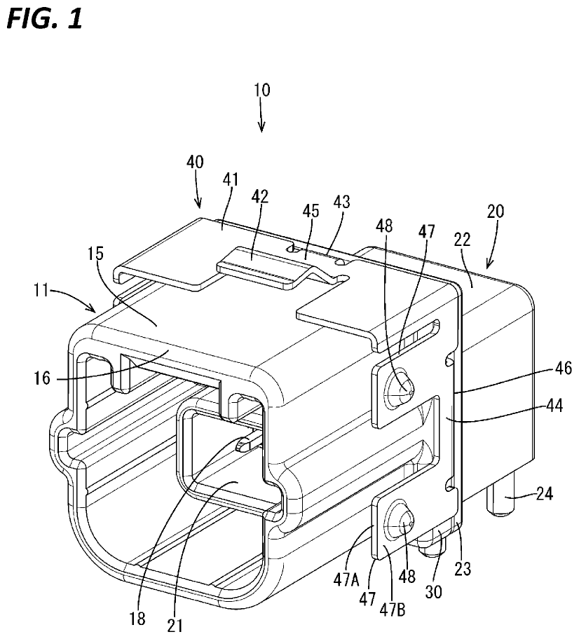

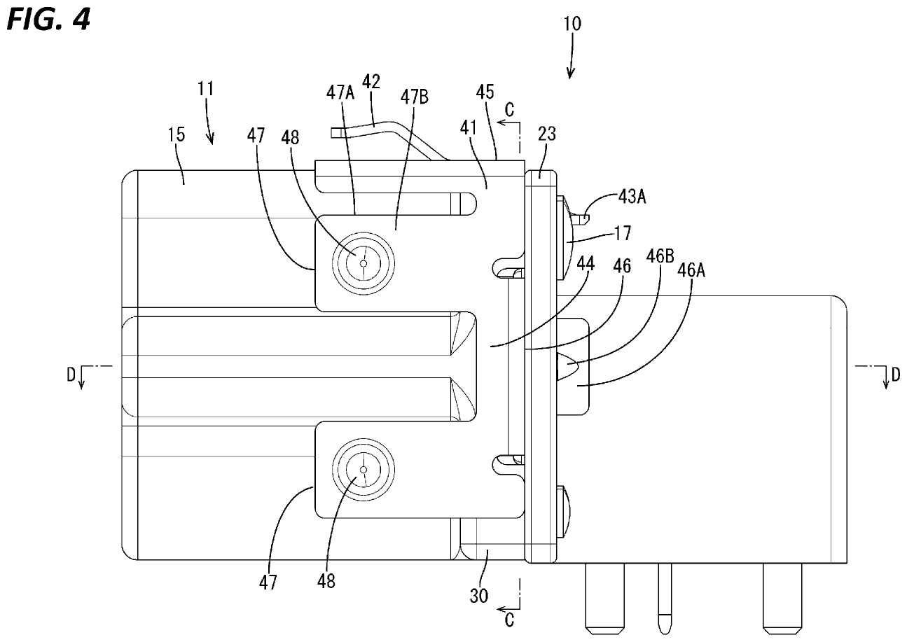

Specific examples of a board connector 10 and a device 60 of the present disclosure are described with reference to FIGS. 1 to 14. Note that the present disclosure is not limited to these illustrations, but is represented by claims and intended to include all changes in the scope of claims and in the meaning and scope of equivalents.

### [Overall Structures of Board Connector and Device]

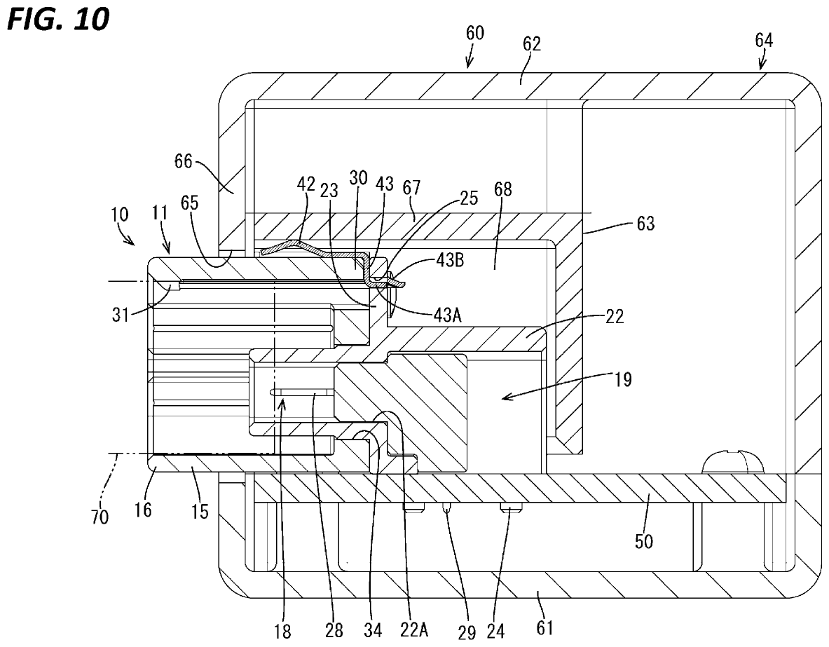

The board connector 10 according to this embodiment is mounted on a circuit board 50 accommodated inside the device 60 as shown in FIG. 10. A front-rear direction is based on a lateral direction in FIG. 10 with a left side set as a front side, and a vertical direction is based on a vertical direction in FIG. 10. Further, for a plurality of identical members, only some members may be denoted by a reference sign and the other members may not be denoted by the reference sign.

### [Device]

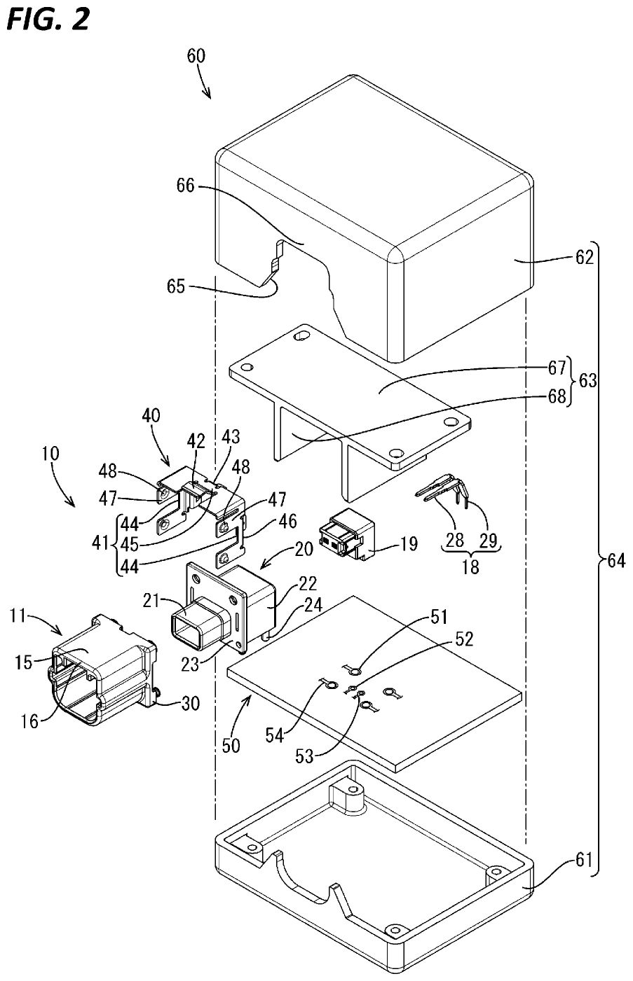

As shown in FIG. 2, the device 60 is provided with a lower case 61 open upward, an upper case 62 for closing an upper opening of the lower case 61 by being assembled with the lower case 61 from above, and a connecting component 63 to be assembled with the upper case 62 from below. The lower case 61, the upper case 62 and the connecting component 63 are made of electrically conductive metal and formed by die casting. The lower case 61, the upper case 62 and the connecting component 63 are integrally assembled by a known method such as screwing or locking structures, whereby an enclosure 64 is formed. The enclosure 64 has a rectangular parallelepiped shape as a whole.

A front wall 66 constituted by the lower case 61 and the upper case 62 is provided with a connector insertion hole 65, through which a part of the board connector 10 is inserted.

The connecting component 63 includes a case mounting plate 67 to be mounted on the inner surface of the upper case 62 and a pair of shield connection walls 68 projecting downward in a plate thickness direction from the case mounting plate 67. The pair of shield connection walls 68 are arranged in parallel at a predetermined interval in a lateral direction and arranged to face each other in the lateral direction. A ground spring 40 resiliently contacts facing surfaces of the pair of shield connection walls 68. The connecting component 63 is a component for relay connection for connecting the ground spring 40 and the upper case 62.

The circuit board 50 is accommodated in the enclosure 64. The circuit board 50 is fixed to the enclosure 64 by a known method such as screwing. The circuit board 50 is formed with signal electrically conductive paths 53, in which signals are transmitted, and ground electrically conductive paths 54 by etching a copper foil by known printed wiring technique. A plurality of (four in this embodiment) outer conductor through holes 51 and a plurality of (two in this embodiment) inner conductor through holes 52 are formed at positions near a front end part of the circuit board 50. An electrically conductive path (not shown) is formed on the inner peripheral surface of the outer conductor through hole 51 by through hole copper plating or the like.

The electrically conductive path formed on the inner peripheral surface of the outer conductor through hole 51 is electrically connected to the ground electrically conductive path 54. Further, an electrically conductive path formed on the inner peripheral surface of the inner conductor through hole 52 is electrically connected to the signal electrically conductive path 53. Unillustrated electronic components are connected to the signal electrically conductive paths 53 and the ground electrically conductive paths 54 of the circuit board 50 by a known method such as soldering.

### [Board Connector]

The board connector 10 includes a housing 11, an outer conductor 20 to be attached to the housing 11, a dielectric 19 to be accommodated inside the outer conductor 20, inner conductors 18 to be accommodated inside the dielectric 19 and the ground spring 40 to be connected to the outer conductor 20.

### [Housing]

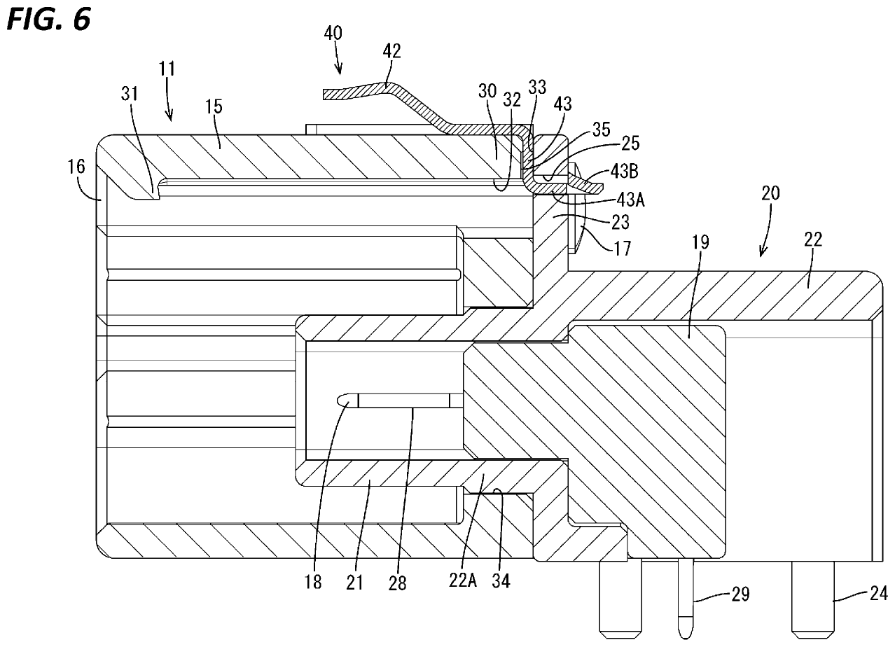

The housing 11 is formed by injection-molding an insulating synthetic resin. The housing 11 includes a receptacle 15, which is open forward and into which a mating connector 70 is fit, and a rear wall 30 provided on a side opposite to a front end side (opening end part) 16 where the receptacle 15 is open. As shown in FIG. 6, a lock portion 31 projecting downward is provided on the front end edge (opening end part) of the inner wall of the receptacle 15. The lock portion 31 is locked to a lock arm (not shown) provided on the mating connector 70, thereby holding the mating connector 70 in a state fit in the receptacle 15.

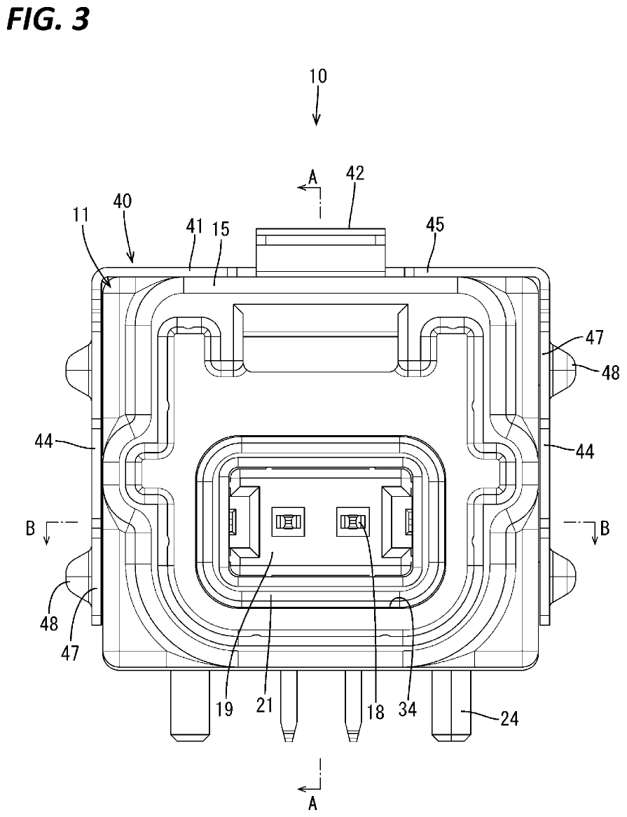

The rear wall 30 is located on a rear end part of the housing 11. As shown in FIG. 2, the rear wall 30 is larger than the receptacle 15 in the lateral direction and has the same size as the receptacle 15 in the vertical direction. As shown in FIG. 6, a mold removal hole 32 for forming the lock portion 31 in injection-molding the housing 11 is formed to penetrate in the front-rear direction at a position of the rear wall 30 behind the lock portion 31. An outer conductor mounting hole 34, through which the outer conductor 20 is inserted, is formed to penetrate in the front-rear direction below the mold removal hole 32 in the rear wall 30. As shown in FIG. 3, the inner peripheral surface of the outer conductor mounting hole 34 has a rectangular shape with rounded corners when viewed from front.

### [Outer Conductor]

As shown in FIG. 2, the outer conductor 20 is made of electrically conductive metal. An arbitrary metal such as copper, copper alloy, zinc, aluminum or aluminum alloy can be appropriately selected as a metal for constituting the outer conductor 20. The outer conductor 20 is formed by a known method such as casting, die casting or cutting. The outer conductor 20 is brought into electrical contact with a mating outer conductor (not shown) accommodated in the mating connector 70.

The outer conductor 20 includes a tube portion 21 extending in the front-rear direction and having a tubular shape, a dielectric surrounding portion 22 extending rearward from the rear end edge of the tube portion 21 and a flange 23 projecting in a direction intersecting the front-rear direction on a boundary part between the tube portion 21 and the dielectric surrounding portion 22.

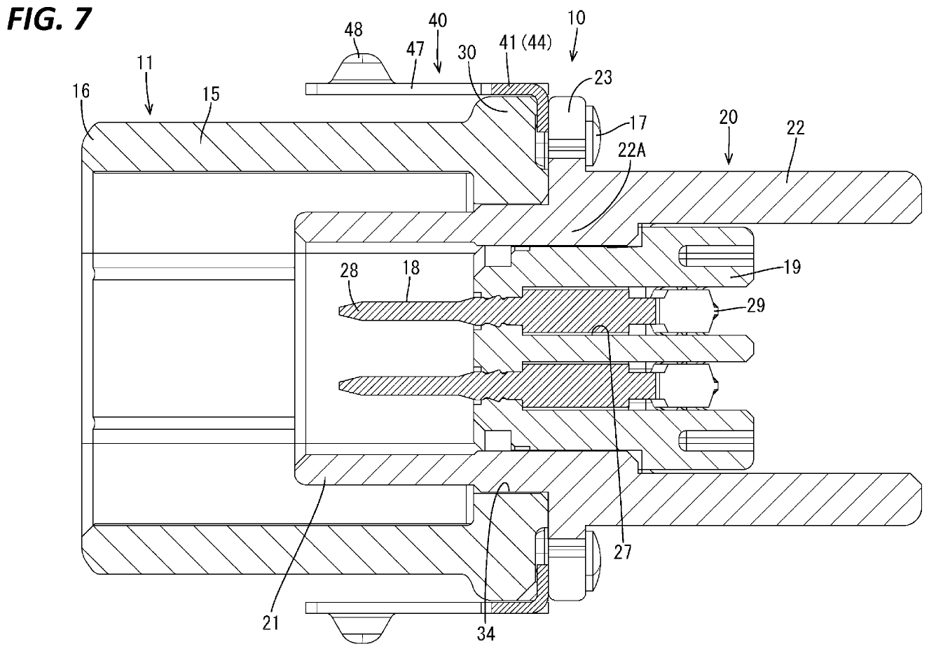

As shown in FIG. 7, a dielectric holding portion 22A for holding the dielectric 19 inside is provided to be open in the front-rear direction in the boundary part between the tube portion 21 and the dielectric surrounding portion 22. The dielectric 19 is held in the outer conductor 20 by being press-fit into the dielectric holding portion 22A.

As shown in FIG. 3, the outer peripheral surface of the tube portion 21 has a rectangular shape with rounded corners when viewed from front. The outer peripheral shape of the tube portion 21 is set to have substantially the same size as the inner peripheral shape of the outer conductor mounting hole 34 of the rear wall 30. In this way, the tube portion 21 is fixed to the housing 11 by being press-fit into the outer conductor mounting hole 34 from behind.

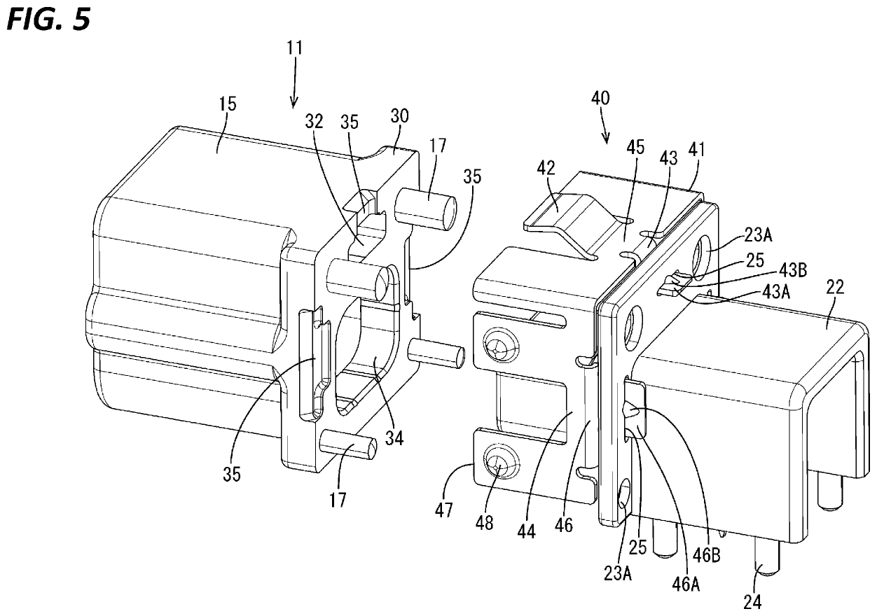

As shown in FIG. 5, the dielectric surrounding portion 22 has a gate shape open downward when viewed from behind. The dielectric 19 is accommodated inside the dielectric surrounding portion 22 while being surrounded on upper, left and right sides by the dielectric surrounding portion 22.

A plurality of (four in this embodiment) cylindrical board connecting portions 24 projecting downward are provided on a lower end part of the dielectric surrounding portion 22. The board connecting portion 24 is inserted into the outer conductor through hole 51 of the circuit board 50 and connected to the conductive path formed on the inner surface of the outer conductor through hole 51 by a known method such as soldering. In this way, the outer conductor 20 is electrically connected to the ground electrically conductive paths 54 formed in the circuit board 50.

As shown in FIG. 6, with the tube portion 21 press-fit to the inner wall of the outer conductor mounting hole 34, the flange 23 is in contact with the rear surface of the rear wall 30 from behind. In this way, the mold removal hole 32 of the rear wall 30 is closed from behind by the flange 23.

### [Attachment Structure of Housing and Outer Conductor]

A plurality of (four in this embodiment) mounting protrusions 17 are provided to project rearward on the rear surface of the rear wall 30 of the housing 11. On the other hand, the flange 23 of the outer conductor 20 is provided with a plurality of (four in this embodiment) mounting holes 23A penetrating in the front-rear direction. The respective mounting protrusions 17 and the respective mounting holes 23A are arranged to correspond in the front-rear direction. With the flange 23 held in contact with the rear surface of the rear wall 30, the respective mounting protrusions 17 are passed through the respective mounting holes 23A and project rearward. Here, projecting parts of the respective mounting protrusions 17 are thermally caulked, whereby tip parts of the respective mounting protrusions 17 are expanded in diameter, and these diameter-expanded parts are locked to hole edge parts of the mounting holes 23A from behind, whereby the outer conductor 20 is held in a state attached to the housing 11. Therefore, the outer conductor 20 is fixed to the housing 11 by press-fitting and thermal caulking.

### [Dielectric]

As shown in FIG. 2, the dielectric 19 is formed by injection-molding an insulating synthetic resin. The dielectric 19 is formed to have a substantially L-shaped cross-section. The dielectric 19 includes inner conductor accommodation chambers 27 capable of accommodating the inner conductors 18 inside. As shown in FIG. 7, the inner conductor accommodation chamber 27 is formed to penetrate through the dielectric 19 in the front-rear direction and also be open on a lower surface side.

### [Inner Conductors]

The inner conductor 18 is made of electrically conductive metal. An arbitrary metal such as copper, copper alloy, aluminum or aluminum alloy can be appropriately selected as a metal for constituting the inner conductor 18. The inner conductor 18 is formed by a known method such as press-working or cutting. The inner conductor 18 is electrically connected to a mating inner conductor (not shown) accommodated in the mating connector 70.

As shown in FIG. 2, the inner conductor 18 is formed by bending a tab-like metal plate halfway. The inner conductor 18 is bent into an L shape as a whole. The inner conductor 18 includes a terminal connecting portion 28 to be connected to the mating inner conductor (not shown) and a board connecting portion 29 to be connected to the inner conductor through hole 52 of the circuit board 50.

As shown in FIG. 6, the terminal connecting portion 28 is shaped to extend in the front-rear direction and projects further forward than the front end of the dielectric 19. On the other hand, the board connecting portion 29 projects further downward than the lower end of the dielectric 19. Thus, the board connecting portion 29 is electrically connected to the signal electrically conductive path 53 of the circuit board 50 by being connected to the inner conductor through hole 52 by a known method such as soldering.

### [Ground Spring]

The ground spring 40 is made from an electrically conductive metal plate. An arbitrary metal such as copper, copper alloy, aluminum or aluminum alloy can be appropriately selected as a metal for constituting the ground spring 40. The ground spring 40 is formed by a known method such as press-working or cutting.

The ground spring 40 includes a gate-shaped mounting body portion 41 and a connection spring 42 and a plurality of resilient pieces 47 projecting forward from the front edge of the mounting body portion 41. The mounting body portion 41 includes a pair of arm portions 44 arranged in parallel at a predetermined interval in the lateral direction and a coupling portion 45 coupling the base ends of the pair of arm portions 44.

Only one connection spring 42 is provided in a central part of the coupling portion 45. The connection spring 42 extends forward from the front edge of the mounting body portion 41 and is formed into a chevron shape with a top on an upper side. The connection spring 42 is resiliently deformable, and resiliently contacts the case mounting plate 67 of the connecting component 63 from below. Note that a plurality of the connection springs 42 may be provided.

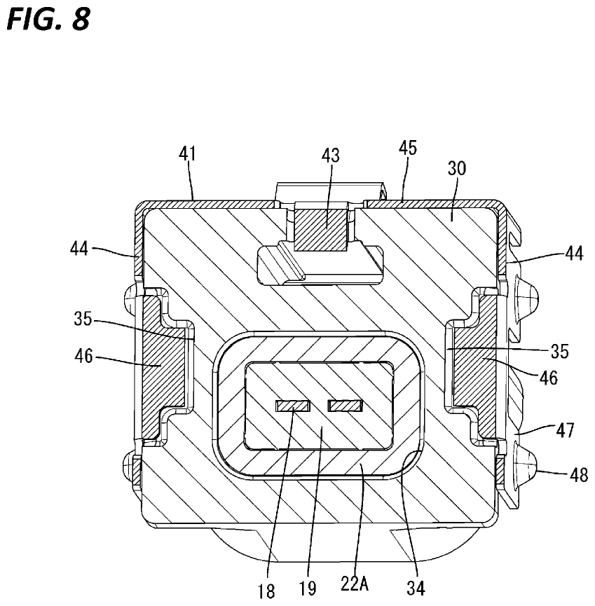

A pair of arm portion side projecting pieces 46 are provided to project inward on the rear edges of the pair of arm portions 44. As shown in FIG. 8, the left arm portion side projecting piece 46 projects rightward, and the right arm portion side projecting piece 46 projects leftward. The pair of arm portion side projecting pieces 46 are arranged side by side in the lateral direction and provided at positions near lower end parts of the arm portions 44. On the other hand, a coupling portion side projecting piece 43 is provided to project downward on the rear edge of the coupling portion 45. The coupling portion side projecting piece 43 is provided at a center position of the coupling portion 45.

A pair of the resilient pieces 47 are provided on the front edge of each of the pair of arm portions 44. The pair of resilient pieces 47 in each arm portion 44 are arranged in parallel at a predetermined interval in the vertical direction. That is, a total of four resilient pieces 47 are provided in this embodiment. The resilient piece 47 has a rectangular shape long in the front-rear direction. The resilient piece 47 is resiliently deformable.

A contact point portion 48 is provided on a front end side of the resilient piece 47. The contact point portion 48 has a curved surface shape projecting toward the enclosure 64 in an assembled state of the enclosure 64. The contact point portion 48 is formed by causing an inner part 47B of the resilient piece 47 except an outer peripheral edge part 47A to project in a plate thickness direction. Such a contact point portion 48 is formed by striking a metal plate serving as a base material, for example, by embossing. Therefore, the contact point portion 48 has the same projecting chevron shape when viewed from any direction orthogonal to a projecting direction thereof.

### [Mounting Structure of Ground Spring and Flange]

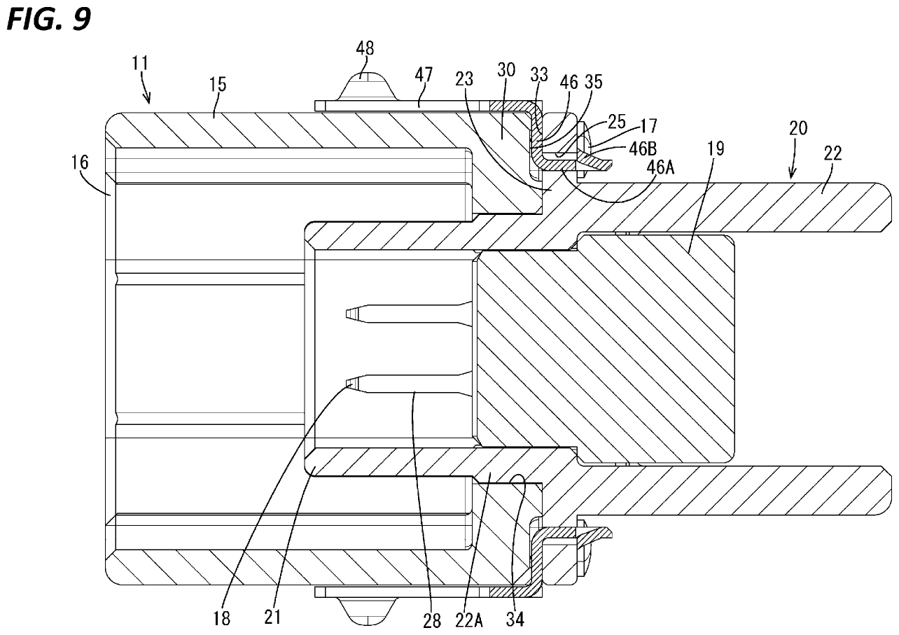

A retaining piece 43A, 46A extending rearward is provided on the projecting end of each projecting piece 43, 46. As shown in FIG. 5, insertion holes 25 are provided to penetrate through the flange 23 in the front-rear direction at positions corresponding to the respective retaining pieces 43A. Projections 43B, 46B are respectively provided on tip sides of the respective retaining pieces 43A, 46A. As shown in FIGS. 6 and 9, if the respective retaining pieces 43A, 46A are inserted through the respective insertion holes 25, the respective projections 43B, 46B are locked to the hole edge parts of the respective insertion holes 25 from behind, whereby the ground spring 40 is fixed to the flange 23.

Escaping recesses 35 are provided at positions corresponding the respective projecting pieces 43, 46 in the rear surface of the rear wall 30 of the housing 11. The escaping recess 35 is formed by recessing the rear surface of the rear wall 30 forward. With the housing 11 and the outer conductor 20 assembled, mounting grooves 33 are formed by the escaping recesses 35 and the flange 23. The mounting grooves 33 are located between the rear wall 30 and the flange 23, and the respective projecting pieces 43, 46 are accommodated into the mounting grooves 33.

As shown in FIG. 6, the mounting groove 33 for accommodating the coupling portion side projecting piece 43 is open upward, and this mounting groove 33 and the insertion hole 25 corresponding thereto communicate. As shown in FIG. 9, the mounting grooves 33 for accommodating the arm portion side projecting pieces 46 are open laterally, and these mounting grooves 33 and the insertion holes 25 corresponding thereto communicate.

### [Connection Structure of Outer Conductor and Ground Spring]

As shown in FIG. 6, the coupling portion side projecting piece 43 is inserted into the corresponding insertion hole 25 and the projection 43B of the retaining piece 43A is locked to the hole edge part of the insertion hole 25 from behind. In this locked state, at least either one of the coupling portion side projecting piece 43 and the retaining piece 43A is in resilient contact with the flange 23, wherefore the ground spring 40 and the outer conductor 20 are electrically connected.

As shown in FIG. 9, the arm portion side projecting pieces 46 are inserted into the corresponding insertion holes 25 and the projections 46B of the retaining pieces 46A are locked to the hole edge parts of the insertion holes 25 from behind. In this locked state, at least either the arm portion side projecting pieces 46 or the retaining pieces 46A are in resilient contact with the flange 23, wherefore the ground spring 40 and the outer conductor 20 are electrically connected.

### [Connection Structure of Ground Spring and Front Panel]

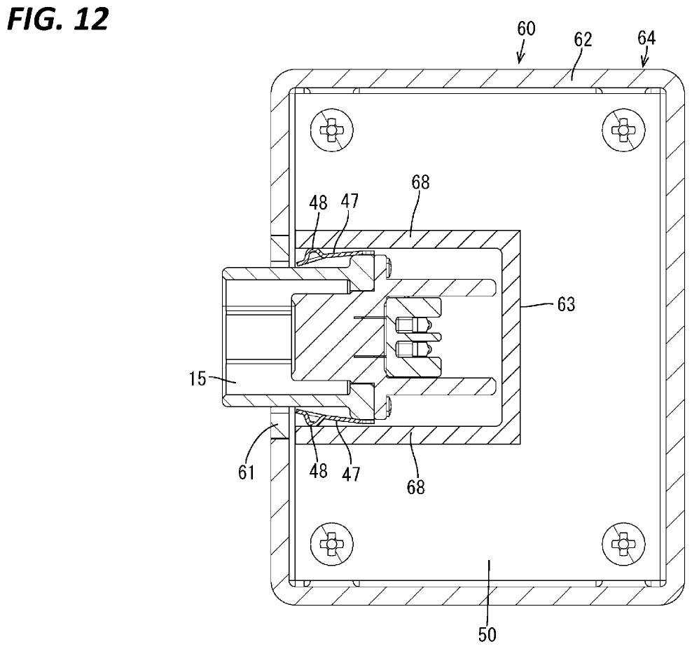

As shown in FIG. 10, at least either one of the coupling portion side projecting piece 43 and the retaining piece 43A is in resilient contact with the flange 23 and the connection spring 42 is in resilient contact with the case mounting plate 67 of the connecting component 63 from below. Further, at least either the pair of arm portion projecting pieces 46 or the retaining pieces 46A are in resilient contact with the flange 23 as shown in FIG. 9, and the contact point portions 48 of the pairs of resilient pieces 47 are respectively laterally in resilient contact with the pair of shield connection walls 68 of the connecting component 63 as shown in FIG. 12. Thus, an electrically conductive path from the flange 23 to the connecting component 63 is shortest, wherefore shielding performance can be improved.

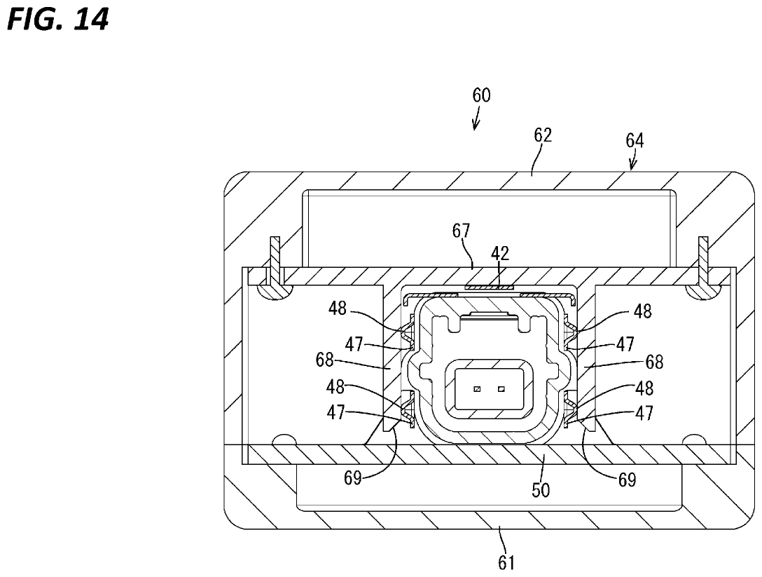

As shown in FIG. 14, there is a single electrically conductive path from the coupling portion projecting piece 43 toward the case mounting plate 67 of the connecting component 63, whereas there are a plurality of (two in this embodiment) electrically conductive paths from each arm portion projecting piece 46 to each shield connection wall 68 of the connecting component 63 by the presence of the plurality of resilient pieces 47. Since the ground spring 40 is connected to the connecting component 63 at multiple contact points in this way, resistance at each contact point is reduced and shielding performance can be further improved.

### [Assembly Method of Board Connector and Device]

Next, an example of an assembly method of the board connector 10 and the device 60 of this embodiment is described. The assembly method of the board connector 10 and the device 60 is not limited to the one described below.

The inner conductors 18 are inserted into the inner conductor accommodation chambers 27 of the dielectric 19 from behind. Subsequently, the inner conductors 18 are assembled with the outer conductor 20 from behind. In this way, a part of the dielectric 19 extending in the front-rear direction is press-fit into the dielectric holding portion 22A of the outer conductor 20 and the dielectric 19 is held retained. In this state, the terminal connecting portions 28 of the inner conductors 18 are accommodated inside the tube portion 21 (see FIG. 9).

Subsequently, the respective retaining pieces 43A, 46A of the ground spring 40 are inserted into the respective insertion holes 25 of the flange 23 from front. At the same time as the projections 43B, 46B of the respective retaining pieces 43A, 46A pass through the respective insertion holes 25, the respective projections 43B, 46B are locked to the hole edge parts of the respective insertion holes 25 from behind. In this way, the ground spring 40 is mounted and fixed to the flange 23 of the outer conductor 20.

Subsequently, the tube portion 21 of the outer conductor 20 is inserted into the outer conductor mounting hole 34 of the housing 11 from behind and the dielectric holding portion 22A is press-fit into the outer conductor mounting hole 34. Simultaneously with this, the respective mounting protrusions 17 of the housing 11 are inserted into the respective mounting holes 23A of the outer conductor 20. Then, the tip parts of the respective mounting protrusions 17 projecting rearward from the respective mounting holes 23A are thermally caulked, whereby the outer conductor 20 is attached and fixed to the housing 11. In this way, the board connector 10 is completed and the flange 23 is disposed along the rear wall 30 of the housing 11.

Subsequently, the board connector 10 is assembled with the circuit board 50 from above. The board connecting portions 24 of the outer conductor 20 are inserted into the outer conductor through holes 51 of the circuit board 50 from above, and the board connecting portions 29 of the inner conductors 18 are inserted into the inner conductor through holes 52 of the circuit board 50 from above and soldered, whereby the board connecting portions 29 and the inner conductor through holes 52 are electrically connected.

Subsequently, the circuit board 50 is fixed to the lower case 61, such as by screwing, and the connecting component 63 is fixed to the inner surface of the upper case 62, such as by screwing. Then, the upper case 62 is assembled with the lower case 61, and the lower case 61 and the upper case 62 are fixed, such as by screwing. In this way, the enclosure 64 is configured and the board connector 10 and the circuit board 50 are accommodated inside the enclosure 64 with the receptacle 15 passed through the connector insertion hole 65.

Here, an assembly direction of the enclosure 64 may be such that the upper case 62 is assembled from above the lower case 61 and the upper case 62 is assembled from behind the lower case 61, and can be freely selected depending on an assembly environment at a delivery destination. As shown in FIG. 10, since the connection spring 42 is cantilevered forward, there is no big difference in workability when the lower case 61 is assembled from above and when the lower case 61 is assembled from below, and the lower case 61 can be smoothly assembled while the connection spring 42 is prevented from being turned up and broken.

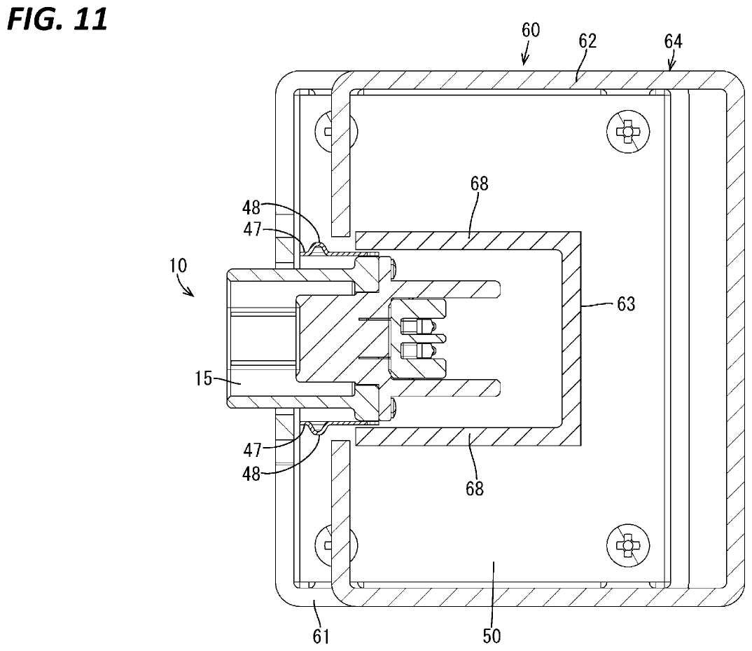

FIGS. 11 and 12 show a case where the upper case 62 is assembled from behind the lower case 61. While the enclosure 64 is being assembled, the front edges of the respective shield connection walls 68 of the connecting component 63 start to slide on inclined surfaces of the respective contact point portions 48 and the respective resilient pieces 47 start to be deflected toward the receptacle 15 to displace the respective contact point portions 48 if the upper case 62 is brought closer to the lower case 61 as shown in FIG. 11. After the assembly of the enclosure 64 is completed, tops of the respective contact point portions 48 are in resilient contact with the respective shield connection walls 68 as shown in FIG. 12.

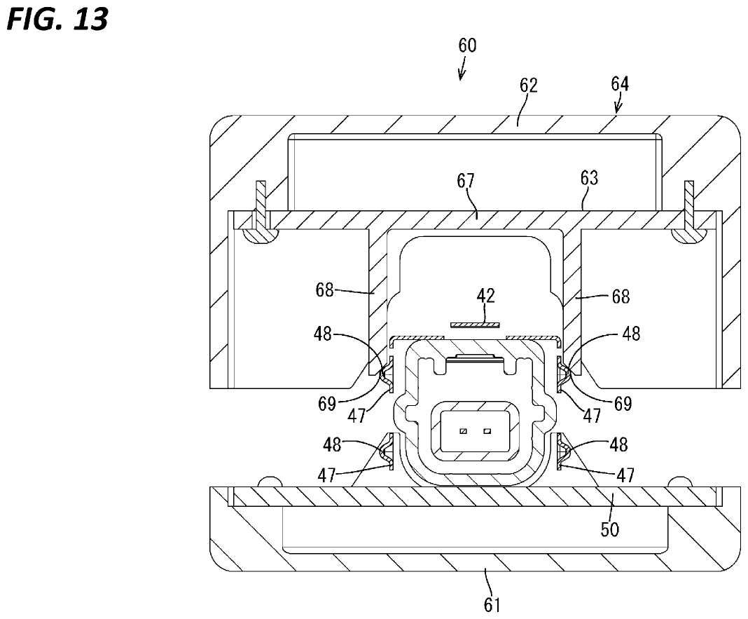

On the other hand, FIGS. 13 and 14 show a case where the upper case 62 is assembled from above the lower case 61. Tapered surfaces 69 are respectively provided on the lower edges of the respective shield connection walls 68 of the connecting component 63. While the enclosure 64 is being assembled, the tapered surfaces 69 of the respective shield connection walls 68 of the connecting component 63 start to slide on the inclined surfaces of the respective contact point portions 48 and the respective resilient pieces 47 start to be deflected toward the receptacle 15 to displace the respective contact point portions 48 as shown in FIG. 13 if the upper case 62 is brought closer to the lower case 61. After the assembly of the enclosure 64 is completed, the tops of the respective contact point portions 48 are in resilient contact with the respective shield connection walls 68 as shown in FIG. 14.

In this way, the ground spring 40 is electrically connected to the enclosure 64 at multiple contact points by the connection spring 42 and the plurality of contact point portions 48. That is, the outer conductor 20 is shield-connected to the enclosure 64 via the ground spring 40. Apart from this, the outer conductor 20 is shield-connected to the enclosure 64 via the plurality of board connecting portions 24 and the circuit board 50, but a distance to the enclosure 64 can be short and the ground spring 40 resiliently contacts the enclosure 64 with shield connection by the ground spring 40. Thus, a connected state is stable and shielding performance can be improved.

Subsequently, the board connector 10 and the mating connector 70 are connected. If the mating connector 70 is fit into the receptacle 15, the lock arm (not shown) provided on the mating connector 70 is locked to the lock portion 31. In this way, the mating connector 70 is held retained in the housing 11. The inner conductors 18 of the board connector 10 are electrically connected to the mating inner conductors (not shown) of the mating connector 70. Further, the outer conductor 20 of the board connector 10 is electrically connected to the mating outer conductor (not shown) of the mating connector 70.

### Functions and Effects of First Embodiment

The board connector 10 of the present disclosure is to be mounted on the circuit board 50 accommodated inside the enclosure 64 made of metal, and provided with the housing 11 including the receptacle 15 open forward and the rear wall 30 provided on the side opposite to the front end part 16 where the receptacle 15 is open, the outer conductor 20 fixed to the housing 11 through the rear wall 30, the insulating dielectric 19 disposed inside the outer conductor 20, the inner conductors 18 disposed inside the dielectric 19 and the ground spring 40 to be connected to the outer conductor 20. The ground spring 40 includes the contact point portions 48 having a curved surface shape projecting toward the enclosure 64, and the contact point portions 48 resiliently contact the enclosure 64.

The device 60 of the present disclosure is provided with the board connector 10, the circuit board 50 having the board connector 10 mounted thereon, and the enclosure 64 made of metal, configured to accommodate the circuit board 50 inside and electrically connected to the outer conductor 20 via the ground spring 40. The enclosure 64 includes the shield connection walls 68 configured to slide on the contact point portions 48 during the assembly of the enclosure 64 and resiliently contact the contact point portions 48 after the assembly of the enclosure 64 is completed.

Since the ground spring 40 includes the contact point portions 48 having a curved surface shape projecting toward the enclosure 64, the shield connection walls 68 slide on the contact point portions 48 during the assembly of the enclosure 64 and resiliently contact the contact point portions 48 after the assembly of the enclosure 64 is completed. Therefore, the ground spring 40 can be prevented from being partially turned up and broken, and the assembly direction of the enclosure 64 can be freely selected. Further, since the outer conductor 20 and the enclosure 64 made of metal can be electrically connected via the ground spring 40, the connected state is stable and shielding performance can be improved.

The ground spring 40 includes the mounting body portion 41 to be disposed along the outer surface of the rear wall 30 and the resilient pieces 47 projecting forward from the front edge of the mounting body portion 41, and the contact point portions 48 are provided on the front end sides of the resilient pieces 47.

When the enclosure 64 contacts the contact point portions 48, the contact point portions 48 are displaced while deflecting the resilient pieces 47 and the contact point portions 48 resiliently contact the enclosure 64 by the resilient return of the resilient pieces 47.

The mounting body portion 41 is gate-shaped and includes the pair of arm portions 44 and the coupling portion 45 coupling the pair of arm portions 44, and at least one resilient piece 47 is provided in each of the pair of arm portions 44.

Since the ground spring 40 includes at least a pair of the resilient pieces 47, the ground spring 40 can be shield-connected to the enclosure 64 at least at two positions and noise can be reduced.

A pair of the resilient pieces 47 are provided in one arm portion, and a pair of the resilient pieces 47 are provided in the other arm portion 44.

Since the ground spring 40 includes four resilient pieces, the ground spring 40 can be shield-connected to the enclosure 64 at least at four positions and noise can be further reduced.

The contact point portion 48 is formed by causing the inner part 47B of the resilient piece 47 except the outer peripheral edge part 47A to project in the plate thickness direction.

Since the contact point portion 48 is constituted by the inner part 47B of the resilient piece 47, the resilient piece 47 can be prevented from being turned up, such as due to the enclosure 64 caught by the outer peripheral edge part 47A of the resilient piece 47.

### Details of Second Embodiment of Present Disclosure

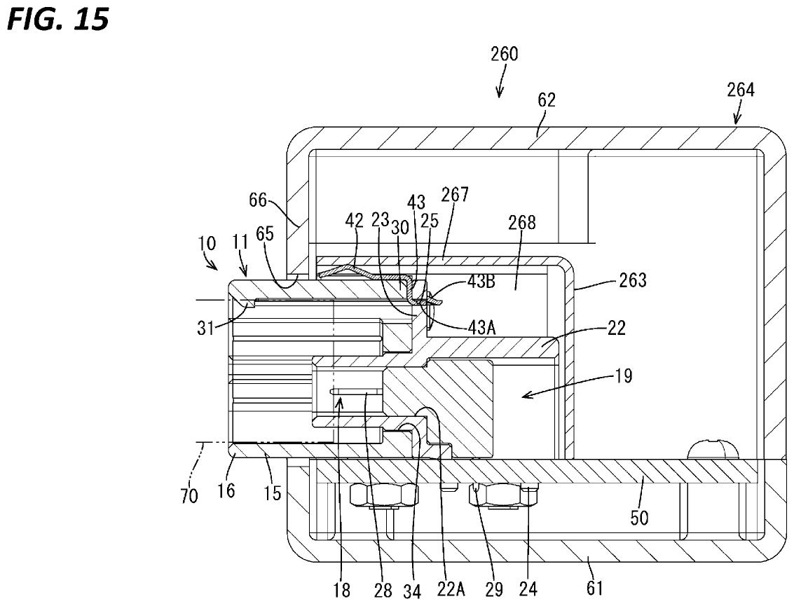

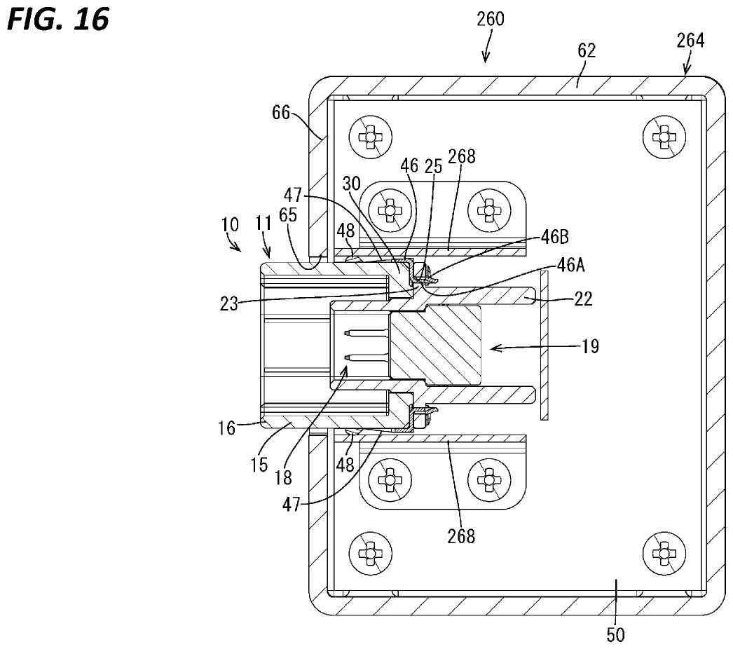

Specific examples of a board connector 10 and a device 260 of the present disclosure is described with reference to FIGS. 15 and 16. In the following description, the same components as in the first embodiment are not described and reference sings obtained by adding 200 to numeric parts of the reference signs are used for components corresponding to those of the first embodiment.

### [Overall Structures of Board Connector and Device]

In this embodiment, the connecting component 63 of the first embodiment is changed and the other configuration is the same. The connecting component 63 of the first embodiment is formed by die casting, whereas a connecting component 263 of the second embodiment is formed by press-working a metal plate.

The device 260 is provided with a lower case 61 open upward, an upper case 62 for closing an upper opening of the lower case 61 by being assembled with the lower case 61 from above, and the connecting component 263 to be connected to a circuit board 50. The lower case 61, the upper case 62 and the connecting component 263 are made of electrically conductive metal. The lower case 61 and the upper case 62 are formed by die casting. The lower case 61 and the upper case 62 are integrally assembled by a known method such as screwing or locking structures, whereby an enclosure 264 is formed.

The connecting component 263 is mounted on the circuit board 50 and includes a pair of shield connection walls 268 and a ceiling wall 267 coupling the pair of shield connection walls 268. The pair of shield connection walls 268 are arranged in parallel at a predetermined interval in the lateral direction and arranged to face each other in the lateral direction. A ground spring 40 resiliently contacts facing surfaces of the pair of shield connection walls 268. The connecting component 263 is a component for relay connection for connecting the ground spring 40 and the circuit board 50. Unlike the connecting component 63 of the first embodiment, the connecting component 263 of this embodiment is not shield-connected to the enclosure 264, but shield-connected to the circuit board 50.

### [Connection Structure of Ground Spring and Connecting Component]

As shown in FIG. 15, a coupling portion side projecting piece 43 and a retaining piece 43A are in resilient contact with a flange 23, and a connection spring 42 is in resilient contact with the ceiling wall 267 of the connecting component 263. Thus, an electrically conductive path from the flange 23 to the connecting component 263 is shortest, wherefore shielding performance can be improved. As shown in FIG. 16, a pair of arm portion projecting pieces 46 and a pair of retaining pieces 46A are in resilient contact with the flange 23, and a pair of contact point portions 48 are in resilient contact with the pair of shield connection walls 268 of the connecting component 263. Thus, the electrically conductive path from the flange 23 to the connecting component 263 is shortest, wherefore shielding performance can be improved.

### Other Embodiments

(1) Although the case where the upper case 62 is assembled with the lower case 61 from behind and the case where the upper case 62 is assembled with the lower case 61 from above are described in the first and second embodiments, the assembly direction of the upper case 62 is not limited to these.
(2) Although the contact point portion 48 having a curved surface shape is formed by embossing in the first and second embodiments, the shape of the contact point portion 48 is not limited to a spherical surface shape formed by embossing and the contact point portion 48 may be bent into an arcuate shape as when a contact point portion of the connection spring 42 is viewed from front.
(3) Although the contact point portions 48 are provided on the resilient pieces 47 in the first and second embodiments, contact point portions may be provided on the mounting body portion 41. In that case, recesses may be provided at positions corresponding to the contact point portions in the outer peripheral surface of the rear wall 30.
(4) Although the resilient pieces 47 are respectively provided in the pair of arm portions 44 in the first and second embodiments, resilient piece(s) may be provided only in one arm portion.
(5) Although a pair of the resilient pieces 47 are provided in one arm portion 44 in the first and second embodiments, only one resilient piece may be provided in one arm portion.
(6) Although the contact point portion 48 is provided on the inner part 47A of the resilient piece 47 in the first and second embodiments, a contact point portion may be provided on an outer peripheral edge part of a resilient piece.
(7) One, three or more inner conductors 18 may be provided.
(8) The outer conductor may be formed by press-working a metal plate material.
(9) Although the housing and the outer conductor are fixed to each other by press-fitting and thermal caulking, these may be fixed only by press-fitting.

### LIST OF REFERENCE NUMERALS

10: board connector, 11: housing, 15: receptacle, 16: front end part, 17: mounting protrusion, 18: inner conductor, 19: dielectric,
20: outer conductor, 21: tube portion, 22: dielectric surrounding portion, 22A: dielectric holding portion, 23: flange, 23A: mounting hole, 24: board connecting portion, 25: insertion hole, 27: inner conductor accommodation chamber, 28: terminal connecting portion, 29: board connecting portion
30: rear wall, 31: lock portion, 32: mold removal hole, 33: mounting groove, 34: outer conductor mounting hole, 35: escaping recess
40: ground spring, 41: mounting body portion, 42: connection spring, 43: coupling portion side projecting piece, 43A: retaining piece, 43B: projection, 44: arm portion, 45: coupling portion, 46: arm portion side projecting piece, 46A: retaining piece,
46B: projection, 47: resilient piece, 47A: outer peripheral edge part, 47B: inner part, 48: contact point portion
50: circuit board, 51: outer conductor through hole, 52: inner conductor land, 53: signal electrically conductive path, 54: ground electrically conductive path
60: device, 61: lower case, 62: upper case, 63: connecting component, 64: enclosure, 65: connector insertion hole, 66: front wall, 67: case mounting plate, 68: shield connection wall, 69: tapered surface
70: mating connector
260: device, 263: connecting component, 264: enclosure, 267: ceiling wall, 268: shield connection wall

1. A board connector to be mounted on a circuit board accommodated inside an enclosure made of metal, comprising:
a housing including a receptacle open forward and a rear wall provided on a side opposite to a front end part where the receptacle is open;
an outer conductor fixed to the housing through the rear wall;
an insulating dielectric disposed inside the outer conductor;
an inner conductor disposed inside the dielectric; and
a ground spring to be connected to the outer conductor,
the outer conductor including a tube portion extending in a front-rear direction and having a tubular shape, a dielectric surrounding portion extending rearward from a rear end edge of the tube portion and a flange projecting in a direction intersecting the front-rear direction on a boundary part between the tube portion and the dielectric surrounding portion,
the tube portion of the outer conductor penetrating through the rear wall of the housing, the dielectric being disposed inside the dielectric surrounding portion of the outer conductor, the ground spring being connected to the flange of the outer conductor, and
the ground spring including a contact point portion having a curved surface shape projecting toward the enclosure, the contact point portion resiliently contacting the enclosure.

2. The board connector of claim 1, wherein the ground spring includes a mounting body portion to be disposed along an outer surface of the rear wall and a resilient piece projecting forward from a front edge of the mounting body portion, and the contact point portion is provided on a front end side of the resilient piece.

3. The board connector of claim 2, wherein:
the mounting body portion is gate-shaped and includes a pair of arm portions and a coupling portion coupling the pair of arm portions, and
at least one resilient piece is provided in each of the pair of arm portions.

4. The board connector of claim 3, wherein a pair of the resilient pieces are provided in one arm portion and a pair of the resilient pieces are provided in the other arm portion.

5. The board connector of claim 2, wherein the contact point portion is formed by causing an inner part of the resilient piece except an outer peripheral edge part to project in a plate thickness direction.

6. A device, comprising:
the board connector of claim 1;
a circuit board having the board connector mounted thereon; and
an enclosure made of metal, the circuit board being accommodated inside the enclosure, the enclosure being electrically connected to the outer conductor via the ground spring,
the enclosure including a shield connection wall configured to slide on the contact point portion during assembly of the enclosure and resiliently contact the contact point portion after the assembly of the enclosure is completed.
